(19) United States
(12) Patent Application Publication
(10) Pub. No.: US 2010/0017557 A1
(43) Pub. Date: Jan. 21, 2010

(54) MEMORY CONTROLLER, NONVOLATILE MEMORY DEVICE,ACCESS DEVICE, AND NONVOLATILE MEMORY SYSTEM

(75) Inventors: Masahiro Nakanishi, Kyoto (JP); Takuji Maeda, Osaka (JP); Toshiyuki Honda, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/374,678

(22) PCT Filed: Jul. 26, 2007
(86) PCT No.: PCT/JP2007/064675

§ 371 Date: Jan. 22, 2009

(30) Foreign Application Priority Data
Jul. 26, 2006 (JP) 2006-203538

(51) Int. Cl. G06F 12/00; G06F 12/02

(52) U.S. Cl. 711/103; 711/E12.001; 711/E12.008

(57) ABSTRACT

A nonvolatile memory device reads and writes file data according to a file ID designated by an access device. The nonvolatile memory device includes a capacity parameter decision part 260 which generates a capacitance parameter related to a usable capacity of a nonvolatile memory 210. Even if a defective region of the nonvolatile memory is gradually increased as the use is continued, a capacity parameter decision part 161 reduces a normal region in accordance with increase of the defective region. The capacity parameter notification part notifies the reduced capacity parameter to the access device. Based on the notified capacity parameter, the access device manages the total size of all the files to be read and written.

### TECHNICAL FIELD

The present invention relates to a nonvolatile memory device such as a semiconductor memory card having a nonvolatile memory, a memory controller for controlling this device, an access device for accessing said nonvolatile memory device, and a nonvolatile memory system configured by adding the access device as a component to said nonvolatile memory device.

### BACKGROUND ART

A nonvolatile memory device having a rewritable nonvolatile memory is increasingly demanded mainly for a semiconductor memory card. The semiconductor memory card is very high-price compared to an optical disk, media of tape, and the like, however, the demand is widely increasing as a memory medium for a portable apparatus such as a digital still camera and a mobile phone because of merits such as small-size, lightweight, vibration resistance, and easy handling. This semiconductor memory card has a flash memory as a nonvolatile main memory and a memory controller for controlling the memory. The memory controller controls the flash memory on the reading and writing of data in accordance with reading and writing commands from the access device such as a digital still camera and a personal computer. Among potable audio equipments, there is not only a potable audio equipment handling the semiconductor memory card but also an equipment internally mounting the flash memory. In these days, the semiconductor memory card is used not only for the above mentioned consumer use but also, for example, a motion picture recording apparatus for broadcasting and professional use.

Since needing comparatively long time to write and erase data on a memory cell array of a memory unit, the flash memory incorporated in a product such as the semiconductor memory card and the portable audio has a structure able to collectively erase and write data in a plurality of memory cells. Specifically, the flash memory is composed of a plurality of physical blocks each of which includes a plurality of pages, and the erasing is performed in units of the physical blocks and the writing is reformed in units of the pages.

A case where this semiconductor memory card is attached to the access device such as the digital still camera and where the access device manages the semiconductor memory card by using a file system, for example, a FAT file system with regarding the memory card as a removable disk and accesses file data of the memory card will be considered. The FAT file system is for ordering the reading and writing of file data for each “cluster” that is a management unit of the file data by using a file allocation table (hereinafter referred to as a FAT) when the file data is recorded to a recording medium.

A nonvolatile memory system employing the above mentioned FAT file system is described in details, for example, in Patent document 1.

FIG. 1 is a configuration diagram showing a nonvolatile memory system employing the FAT file system, and FIG. 2 shows a correspondence between a logical address space managed by a file system 12 provided to an access device 10 and the physical address space managed by a memory controller 14 provided to a nonvolatile memory device 13. To simplify the description, both of a cluster size and a physical block size are 16 kBytes.

When ordered to write desired file data by an application part 11 provided in the access device 10, the file system 12 allocates the file data to free clusters, for example, C5 and C6 in data region on the logical address (LA) shown in FIG. 2. To write the file data, the file system 12 transfers, to the nonvolatile memory device 13, the file data and a logical address LA for identifying a cluster to which the file data is allocated. The memory controller 14 in the nonvolatile memory device 13 converts the logical address into a physical address (hereinafter referred to as logical-physical conversion), and writes the file data to the physical address PA (for example, B7 and B1) determined by the logical-physical conversion. Such method based on the logical address is hereinafter referred to as “a logical level access system”.

In FIG. 2, a normal region on the physical address space has a size of the entire logical address space, and a spare region on the physical address space is used as a substitute region of the physical block when the physical block in the normal region is turned to be bad. The normal region and the spare region are not physically fixed and arbitrarily change their positions because of the logical-physical conversion, however, they are separately drawn on the figure to be easily understood.

In the logical level access system, when the nonvolatile memory device 13 is used first after a shipment and when a trouble occurs in the nonvolatile memory device 13 for some reasons, format processing is performed. That is, the access device 10 obtains, from the nonvolatile memory device 13 via an external bus, information of a capacity (hereinafter referred to as a usable capacity) of data that the access device 10 can store in the nonvolatile memory device 13. Then, the access device 10 performs the format processing based on a parameter of the capacity so that a size of the entire logical address space can be n×16 kbytes. According to this processing, the access device forms the management region and the data region in the logical address space, generates management information such as the FAT for managing these regions, and writes the management information to the nonvolatile memory device 13 by allocating the information in the management regions (C1 and C2). Additionally, all of the data recorded to the nonvolatile memory device 13 are erased by the format performed during use of the nonvolatile memory device 13 which, for example, had a trouble or like.

Patent document 1: Japanese Unexamined Patent Publication No. 2001-188701

Patent document 2: Japanese Unexamined Patent Publication No. H09-198884

### DISCLOSURE OF THE INVENTION

### Problems to be Solved by the Invention

However, when a size of bad block reaches, because of some factors such as memory defects of the nonvolatile memory 15 in the nonvolatile memory device 13, a size of the spare region preliminarily determined by a format immediately after shipment of the nonvolatile memory device 13, the nonvolatile memory system shown in FIG. 1 used to normally set the nonvolatile memory device 13 to be a safe mode. The safe mode does not allow writing data any more but allows only reading already recorded files. Thus, the nonvolatile memory device 13 cannot be used in a normal mode, namely, in a mode which allows the reading and writing.

Widely used nonvolatile memory 15 is, for example, a NAND type flash memory. However, the guaranteed number of rewriting drastically reduces due to processes for the multiple values and the refinement based on reduction of costs and on needs for enlargement of a capacity. In a conventional single-level NAND flash memory, the guaranteed number of times of rewrite is 10⁵, that is, the guaranteed number of times of rewriting an arbitrary physical block is 10⁵, however, in a multi-level NAND flash memory which has come into a mainstream in recent years, the guaranteed number of times of rewrite is 10⁴ and reduces digits of the number of times by one digit.

For example, a case where fifty pieces of high-resolution pictures each of which have a size of 20 Mbytes is taken by a digital still camera into a nonvolatile memory device of 1 Gbytes, that is, so as to consume all of usable capacity and to dub them to a hard disk of a personal computer will be considered. When used for the professional use repeating this operation 10 times a day, the number of rewriting the nonvolatile memory device reaches the guaranteed number of rewriting in approximately 3 years in accordance with expression (1), and there will be a possibility to set the nonvolatile memory device to the safe mode after approximately 3 years from first use.

10⁴/(365 days×10 times)=approx. 3 years (1)

Meanwhile, the guaranteed number of times of rewriting is merely the number of times guaranteed by a manufacturer of the flash memory, and some physical block potentially accepts the rewriting of more than the guaranteed number of times of rewriting. Accordingly, it cannot be necessarily said how many years the nonvolatile memory device actually falls into the safe mode because of an individual difference of the multi-level NAND flash memory mounted to the nonvolatile memory device.

The guaranteed number of times of rewriting of the multi-level NAND flash memory may be further reduced less than 10⁴ times because of the further refinement. Accordingly, it is an important future problem to keep a period in which the memory card can be used in the normal mode as long as possible.

In consideration of the above described problems, the present invention intends to provide a memory controller, a nonvolatile memory device, an access device, and a nonvolatile memory system which are able to continue to use the nonvolatile memory device in the normal mode allowing the reading and writing even when a size of a bad block exceeds a preliminarily determined size of spare region.

### Means to Solve the Problems

To solve the problems, a controller of the present invention which is connected to a nonvolatile memory, comprises: a read and write controller for writing data and reading data from said nonvolatile memory in accordance with a file ID designated by an outside; a capacity parameter determination part for determining a usable capacity parameter of said nonvolatile memory depending on a degree of defects of said nonvolatile memory; and a capacity parameter notification part for notifying the outside of said capacity parameter.

To solve the problems, a nonvolatile memory device of the present invention which writes data and reads data from said nonvolatile memory in accordance with a file ID designated by an outside, includes: the nonvolatile memory; and a memory controller for writing and reading data to and from said nonvolatile memory, and said memory controller includes: a read and write controller for writing data to said nonvolatile memory and reading data from said nonvolatile memory in accordance with a file ID designated by an outside; a capacity parameter determination part for determining a usable capacity parameter of said nonvolatile memory depending on a degree of defects of said nonvolatile memory; and a capacity parameter notification part for notifying the outside of said capacity parameter.

Every time a value of said capacity parameter is changed, said capacity parameter notification part may notify the outside of the change.

When a value of said capacity parameter is changed by a certain amount, said capacity parameter notification part may notify the outside of the change.

Said nonvolatile memory may be composed of a plurality of physical blocks, and a plurality of said physical block may include: normal blocks used for reading and writing data; and a spare block used for a substitute of a bad physical block, and said capacity parameter determination part reduces the number of the normal blocks of said nonvolatile memory in accordance with increase of the bad physical block.

Said capacity parameter determination part may reduce the capacity parameter every time the bad block number of said nonvolatile memory increases.

Said capacity parameter determination part may reduce the capacity parameter in a stepwise fashion every time the bad block number of said nonvolatile memory increases in a stepwise fashion.

To solve the problems, a nonvolatile memory system of the present invention comprises: an access device; and a nonvolatile memory device which writes data and reads data from a nonvolatile memory in accordance with a file ID designated by said access device, wherein said nonvolatile memory device includes: the nonvolatile memory and a memory controller, and said memory controller includes: a capacity parameter determination part for determining a usable capacity parameter of said nonvolatile memory depending on a degree of defects of said nonvolatile memory; and a capacity parameter notification part for notifying said access device of said capacity parameter.

To solve the problems, an access device which connects with a nonvolatile memory device including a nonvolatile memory, and writes data to said nonvolatile memory device and reads data from said nonvolatile memory in accordance with a file ID, includes: a receiver for receiving a capacity parameter from said nonvolatile memory device; an application for reading and writing data from and to said nonvolatile memory device by designating the file ID and for calculating a usable capacity of said nonvolatile memory device based on said capacity parameter; and a display for displaying information related to the usable capacity of said nonvolatile memory device.

Said application may calculate a remaining capacity by subtracting a capacity of data recorded to said nonvolatile memory device from the usable capacity of the nonvolatile memory device calculated based on said capacity parameter, and said display may display the usable capacity and the remaining capacity of said nonvolatile memory device.

Said application may include: a total capacity manager for detecting that the calculated remaining capacity is equal to or less than a threshold value, and said display may display a file erasure outputted from the total capacity manager.

### EFFECTIVENESS OF THE INVENTION

According to the present invention, in a nonvolatile memory system not premising a conventional “logical level access method” but premising an “access method based on a file ID” in which an access device designates a file to be read and written from and to a nonvolatile memory device, the nonvolatile memory device arbitrarily generates a capacity parameter related to a usable capacity and notifies an access device of it. For this reason, even when a size of a bad block reaches a size of a spare region, the nonvolatile memory device can be continuously used in a normal mode, namely, a mode allowing the reading and writing only by gradually reducing the usable capacity of the nonvolatile memory device, resulting in a long-life of the nonvolatile memory device.

### BRIEF DESCRIPTION OF DRAWINGS

FIG. 1 is a block diagram showing a conventional nonvolatile memory system.

FIG. 2 is a memory map showing a correspondence between a logical address space and a physical address space.

FIG. 3A is a block diagram showing an access device of a nonvolatile memory system according to an embodiment of the present invention.

FIG. 3B is a block diagram showing a nonvolatile memory device of the nonvolatile memory system according to the embodiment of the present invention.

FIG. 4A is a memory map showing a correspondence between a usable capacity of an access device 100 and the physical address space.

FIG. 4B is a memory map showing a correspondence between the usable capacity of the access device 100 and the physical address space.

FIG. 4C is a memory map showing a correspondence between the usable capacity of the access device 100 and the physical address space.

FIG. 5 is a memory map showing a physical region management table.

FIG. 6 is a memory map showing a mapping table.

FIG. 7 is a flowchart showing processing in a capacity parameter determination part.

FIG. 8 is a view showing changes of a capacity parameter corresponding to an increase of the bad block number PBN and of the usable capacity.

FIG. 9 is a flowchart showing processing in a capacity parameter notification part.

FIG. 10 is a flowchart showing processing in the access device 100.

FIG. 11 is a time chart showing an outline of a communication procedure between the access device 100 and the nonvolatile memory device 200.

FIG. 12A is an explanation view showing an example of a linkage of physical blocks storing a file data.

FIG. 12B is an explanation view showing another example of a linkage of physical blocks storing a file data.

### EXPLANATION FOR REFERENCE NUMERALS

100 Access device
110 Interface
111 Receiver
120 Application
121 Total capacity manager
130 User interface
131 Input part
132 Display
200 Nonvolatile memory device
210 Nonvolatile memory
220 Memory controller
230 Interface
240 Read and write controller
241 Physical region management table
242 Mapping table
250 Capacity parameter notification part
251 Gate part
252 RAM
253 Comparing part
260 Capacity parameter determination part
261 ROM
262 Capacity parameter calculation part

### BEST MODE FOR CARRYING OUT THE INVENTION

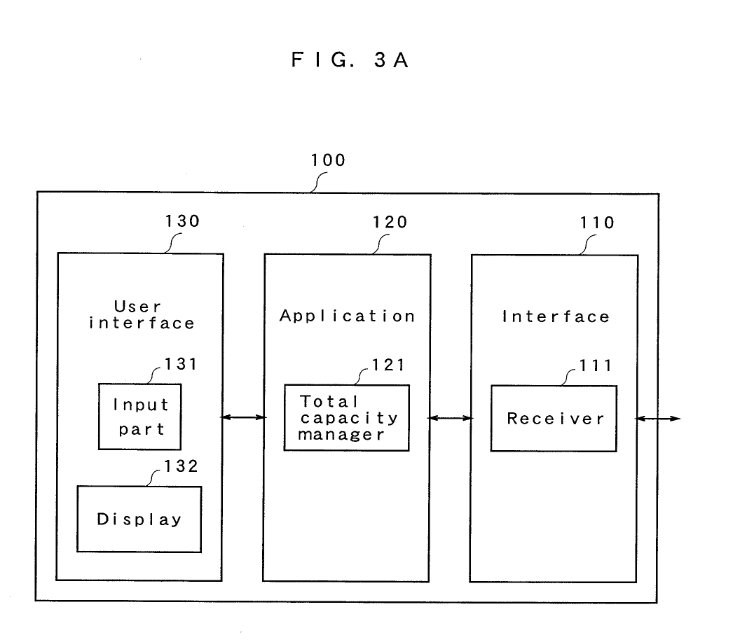

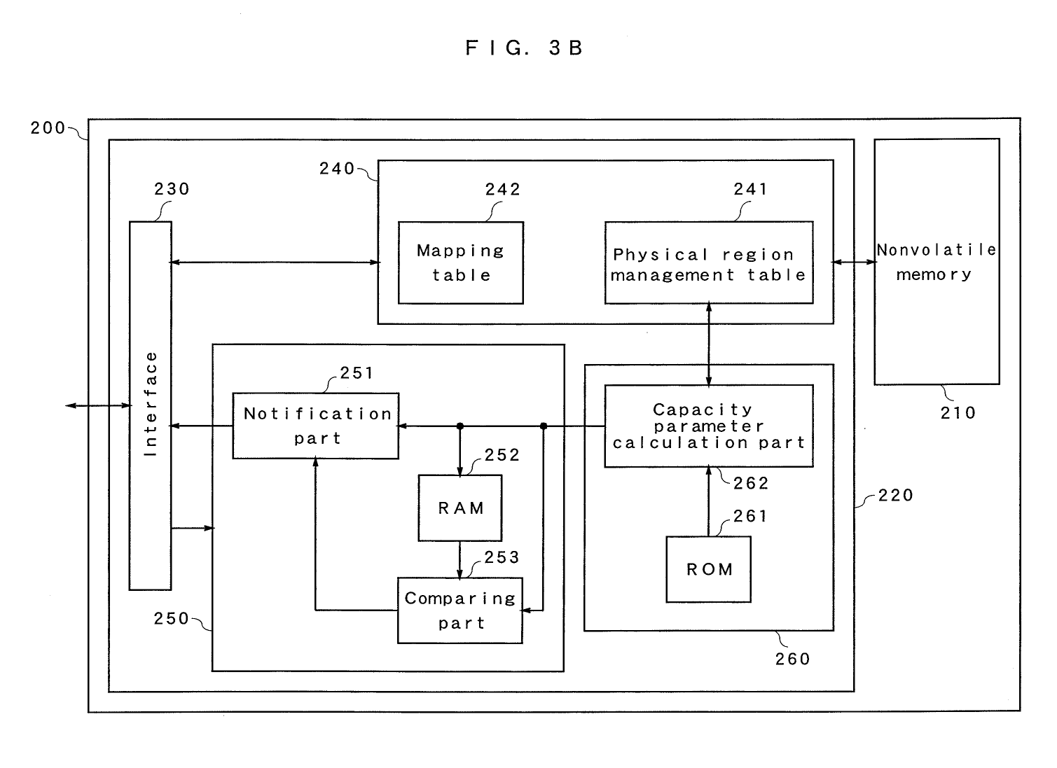

FIG. 3A is a block diagram showing an access device 100 of a nonvolatile memory system according to an embodiment of the present invention, and FIG. 3B shows a nonvolatile memory device 200. The nonvolatile memory system is configured by including the access device 100 and the nonvolatile memory device 200. The access device 100 includes an interface (IF) 110, an application 120, and a user interface 130.

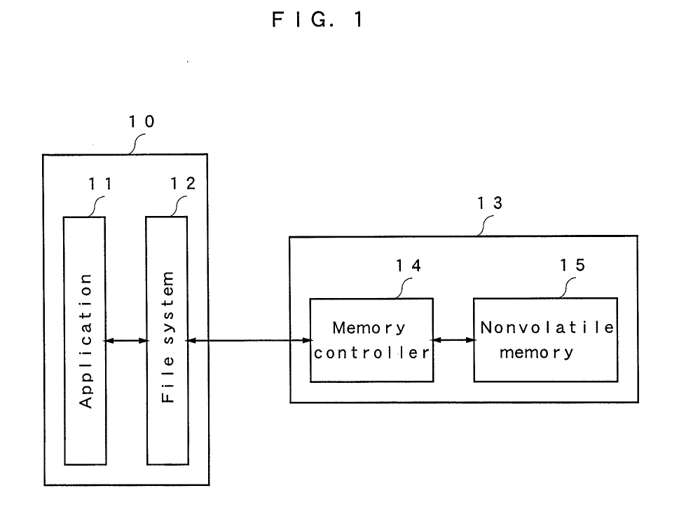

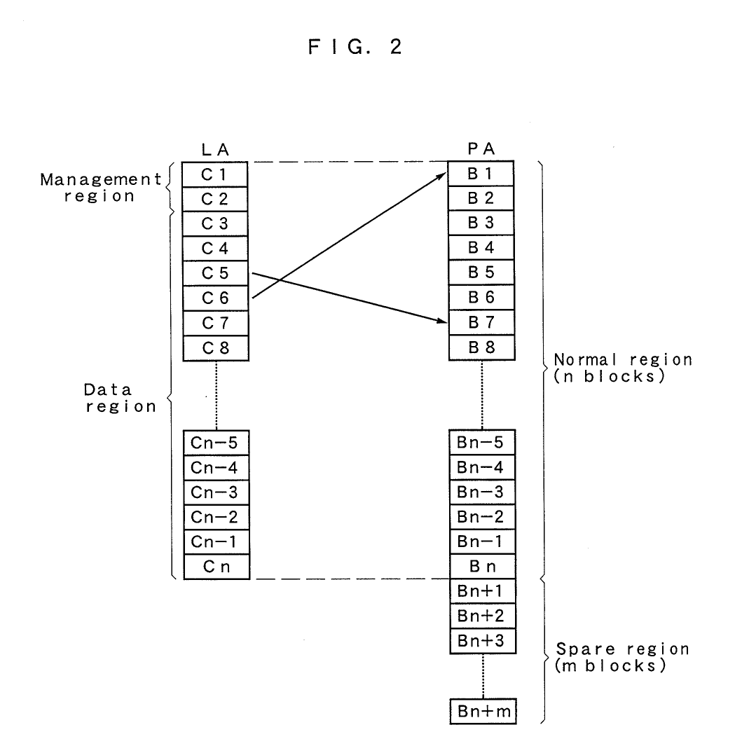

The nonvolatile memory device 200 includes a nonvolatile memory 210 and a memory controller 220. To simplify the description, the nonvolatile memory 210 according to the embodiment is a flash memory composed of physical blocks each of which has a size of 16 kbytes same as the conventional nonvolatile memory system shown in FIG. 1. The memory controller 220 includes an interface 230, a read and write controller 240, a capacity parameter notification part 250, and a capacity parameter determination part 260.

The interface 230 receives a file ID and file data related to the writing and reading of a file from the access device 100, and transmits file data to the access device 100 in the reading of the file. Meanwhile, the file ID is information used for identifying a file, and file number is employed as the file ID in the embodiment.

The read and write controller 240 includes a physical region management table 241 and mapping table 242 composed of a volatile RAM. The physical region management table 241 is a memory map showing a use state of the physical block. The mapping table 242 is a table showing a physical address to the file number. The read and write controller 240 controls the reading and writing of file data received by the interface 230, and performs the reading and writing on the nonvolatile memory 210 based on the file ID.

The capacity parameter notification part 250 includes a notification part 251, a RAM 252, and a comparing part 253, and notifies the access device 100 of the capacity parameter received from a capacity parameter determination part 260 via the interface 130.

The capacity parameter determination part 260 includes a ROM 261 and a capacity parameter calculation part 262. The ROM 261 retains parameters such as the initial physical block number n of a normal region in the physical address space, the physical block number m in the spare region and the total physical block number m+n, a step parameter L, and a mode flag. In a stepwise change mode, the step parameter L indicates the number of physical blocks configured as a new spare region after the number of bad blocks reaches “m” that is the number of the spare regions configured immediately after shipment of the nonvolatile memory device 200. The mode flag is in the stepwise change mode in a case of the value 0 and in a successive change mode in a case of the value 1. In addition, the capacity parameter calculation part 262 determines the capacity parameter based on the bad block number acquired from the physical region management table 241. The capacity parameter indicates the number of physical blocks able to be used as the normal region.

Next, the access device 100 will be explained. The interface 110 of the access device 100 has a receiver 111 for receiving the capacity parameter notified by the nonvolatile memory device. In addition, the application 120 has a total capacity manager 121 for managing, based on the notified value of the capacity parameter, a total capacity of a memory used by an application. Further, the user interface 130 has an input part 131 for accepting an input and erasure from a user of file data and a display 132. The total capacity manager 121 has a function for recommending an erasure of unnecessary files depending on a reduction of the capacity parameter.

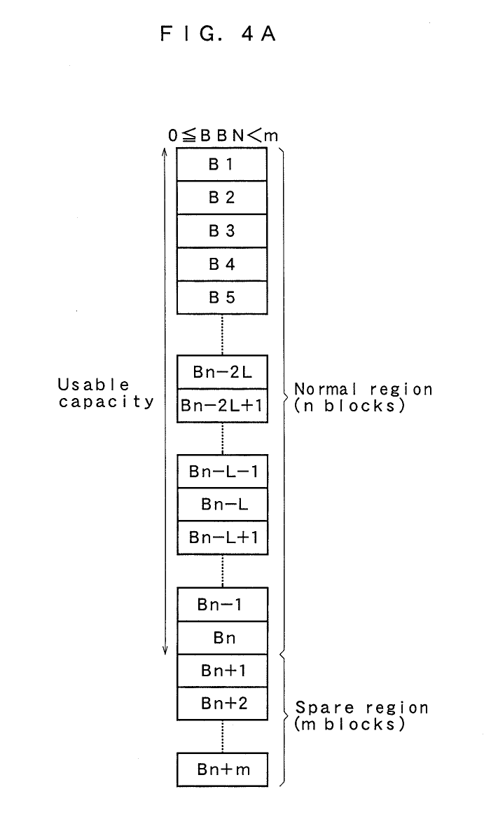

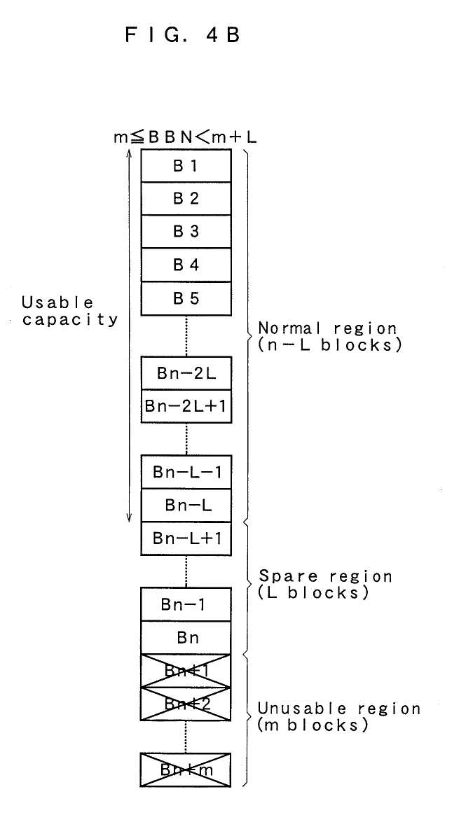

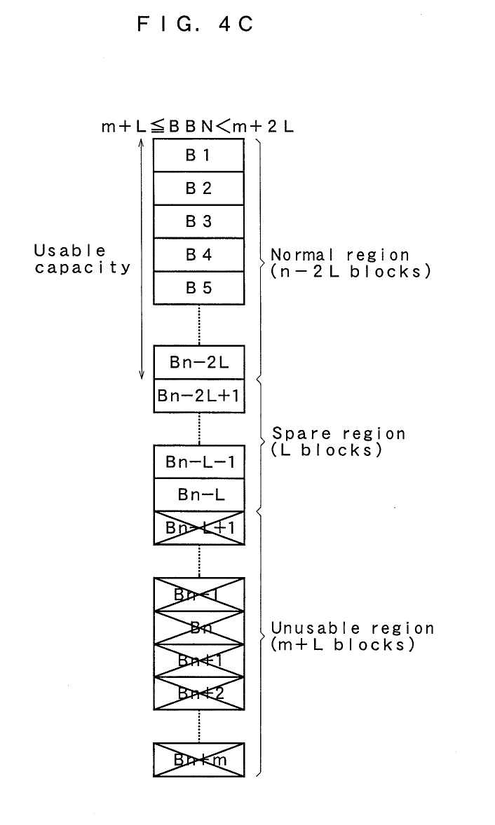

FIG. 4A to FIG. 4C are memory maps showing correspondence between the usable capacity of the access device 100 and the physical address space in the stepwise change mode. In FIG. 4A, a system region storing the system information such as the secure information is abbreviated, the initial physical address space of the nonvolatile memory 210 is composed of two regions of the normal region (n blocks) and the spare region (m blocks). The physical blocks in the normal region and the spare region are not physically fixed but arbitrarily change their positions due to the wear-leveling processing described below. They are separately drawn in the figure to be easily understood. To simplify the description, there is no bad block in the initial state. Here, the usable capacity is a capacity able to accept newly written file data in a state where the nonvolatile memory device 200 has been all cleared, and is not a remaining capacity able to accept additionally written file data in a state where file data has already been written in the nonvolatile memory device 200. FIG. 4A shows a memory map of a case where the bad block number BBN is “0” or more and less than “m” in the nonvolatile memory 210, FIG. 4B shows a memory map of a case where the bad block number BBN is “m” or more and less than “m+L”, and FIG. 4C shows a memory map of a case where the bad block number BBN is “m+L” or more and less than “m+2L”, respectively in the stepwise change mode.

The nonvolatile memory system of the present invention configured as described above will be explained separately in an initial state, in initialization processing at turning on the power, and in processing in a normal operation.

### [Initial State]

At first, contents of processing treatment made on a manufacturer side of the semiconductor memory card before shipment of the nonvolatile memory device 200 will be explained.

When the nonvolatile memory 210, for example, has a capacity of 1 Gbytes and a physical block size of the nonvolatile memory 210 is 16 kbytes, the number of blocks in the physical address space, namely, the value of “m+n” is calculated by expression (2):

m+n=1 Gbytes/16 kbytes=65536 (2).

The values of “m” and “n” may be determined based on conditions such as reliability of the nonvolatile memory 210 to be used. The “m” and “n” are explained as a variable in the embodiment. The value of “m” and “n” and the value of “m+n” are recorded to the ROM 261, and are referred in processing described below of the capacity parameter determination part 260. In the embodiment, since there is no bad block at the initial state as described above, all of the m+n physical blocks can be used.

In addition, the ROM 261 preliminarily stores a value of the mode flag used for determining a method to notify the capacity parameter to be in the stepwise change mode or the successive change mode. In the case of the stepwise change mode, since a value of the parameter L related to the step width is required, the ROM 261 preliminarily stores the value too.

In addition, in a case where the capacity parameter determination part 260 internally has a register, the access device 100 can set the mode flag and the parameter L in the register.

### [Initialization Processing at Turning on the Power]

Next, initialization processing at turning on the power will be explained. By attaching the nonvolatile memory device 200 to the access device 100, the power source is supplied from the access device 100 to the nonvolatile memory device 200 via an external bus, and the nonvolatile memory device 200 shifts to the initialization processing.

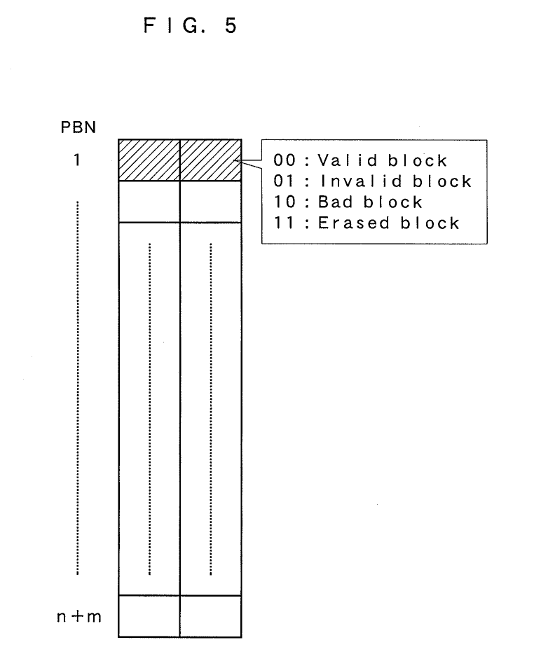

In the initialization processing, the read and write controller 240 creates, based on block statuses stored in management regions of lead pages of all the physical blocks in the nonvolatile memory 210, the physical region management table 241 on the RAM provided in the read and write controller 240. FIG. 5 shows an example of this physical region management table 241. The physical region management table 241 shows use states of the physical blocks corresponding to the physical block number PBN by using the block status of 2 bits. The value 00 of the block status shows a valid block, the value 01 shows an invalid block, the value 10 shows a bad block, and the value 11 shows an erased block.

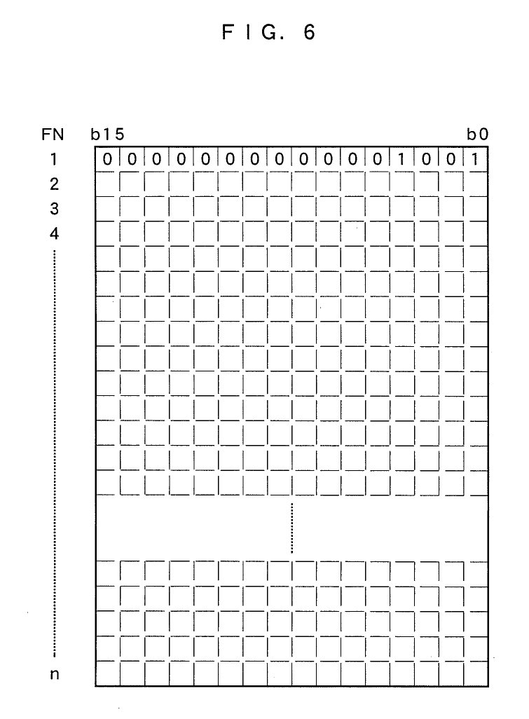

In addition, based on file numbers FN stored in the management regions of the lead pages of all the physical blocks in the nonvolatile memory 210, the read and write controller 240 creates the mapping table 242 showing lead blocks of the file numbers. FIG. 6 is a memory map showing the mapping table 242. Since a configuration of the physical block such as the page and the management region is well known, explanations of the configuration are abbreviated here. In reading and writing data, the physical address is determined using the above mentioned physical region management table 241 and mapping table 242.

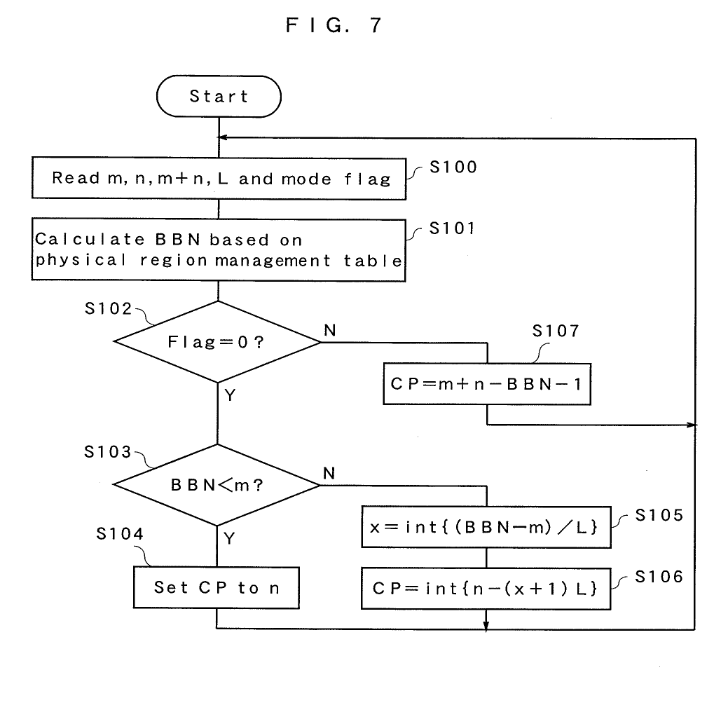

Referring to FIG. 7, processing for generating the capacity parameter which is executed in the initialization processing will be explained. FIG. 7 is a flow chart showing process of the capacity parameter determination part 260. In addition, the capacity parameter determination part 260 executes the processing shown in FIG. 7 also in the normal operation described below.

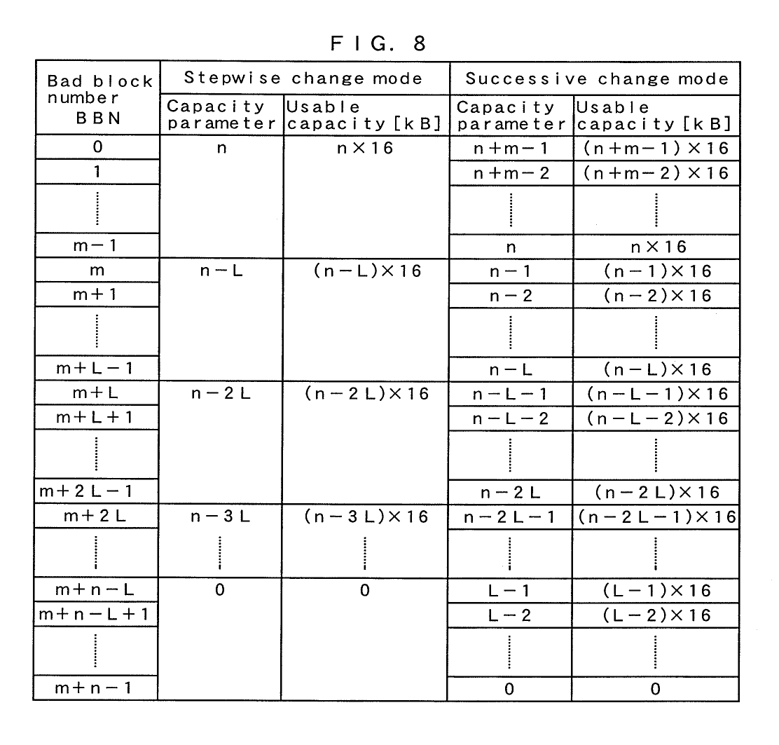

At first, the capacity parameter determination part 260 reads the values of “m”, “n”, “m+n”, and “L” and mode flag preliminarily stored in the ROM 261 (S100). Moreover, the capacity parameter determination part 260 calculates the bad block number BBN (S101) referring to the physical region management table 241. Specifically, the capacity parameter determination part 260 counts the number of the bad blocks whose block statuses are the value 10 in FIG. 5. When there is no bad block immediately after the shipment of the nonvolatile memory device 200 as described above, the value of the bad block number BBN is 0. As shown in FIG. 8, the bad block number BBN increases from the value 0 as the reading and writing of file data to the nonvolatile memory device 200 are repeatedly performed.

In a case where the mode flag read from the ROM 261 is the value 0, that is, in the stepwise change mode, the processing progresses to S103, and in a case where this flag is the value 1, that is, in the successive change mode, the processing progresses to step S107. Firstly, the BBN is compared with the “m” at S103, the capacity parameter CP is set to the “n” when the BBN is smaller than the “m”, that is, the BBN is within a range from 0 to m−1 (S104). On the other hand, when the BBN is the “m” or more, the capacity parameter CP is determined in accordance with expression (3) and expression (4) (S105 and S106):

x=int{(BBN−m)/L) (3),

CP=int{n−(x+1)L} (4).

The expression (3) is used for calculating how many times is the L multiplied to be the BBN−m. In the expression (3), the “int” is a function for obtaining an integer value by truncating decimals of a value in the { }. The expression (4) determines the capacity parameter based on the “x” calculated by the expression (3). Thus, the value of the capacity parameter CP is determined to be one of the values shown in a column of the stepwise change mode in FIG. 8.

Here, it is supplementarily explained to change the capacity parameter CP in the stepwise change mode at a timing when the bad block number BBN changes from the “m−1” to the “m”. This timing of change corresponds to a timing of change from FIG. 4A to FIG. 4B. In FIG. 4A, the spare region (m blocks) is a region used as a alternative block of the physical block when a defect is caused in a written physical block in writing file data to the normal region (n blocks). However, the spare region has not only a role of the aforementioned alternative block but a role of a “work block”. The work block is used in rewriting the file data stored in the normal region, and used in a rewriting procedure; the file data is written in the block and then the physical block in the normal region storing the rewritten file data is erased. In this rewriting procedure, the file data cannot be rewritten without at least one work block in the spare region.

Accordingly, the state of the memory has to be changed to the state of FIG. 4B at the timing when all of the m physical blocks in the spare region are used, namely, the “work block” is “0” in FIG. 4A. For this reason, the capacity parameter is changed at the timing when the BBN is changed from the “m−1” to the “m” in FIG. 8. This also can be said at a timing when the BBN is changed from the “m+L−1” to the “m+L”. The number of the work blocks to be retained varies depending on embodiments, thus that is not an essential problem.

Next, in the case of the successive change mode in FIG. 7, the capacity parameter CP is determined in accordance with expression (5) (S109):

CP=m+n−BBN−1 (5).

Meanwhile, the value 1 on the right side in the expression (5) means that the number of the above mentioned “work block” is one. Thus, the value of the capacity parameter CP is calculated so as to be the value shown in a column of the sequence change mode in FIG. 8.

Here, the usable capacity will be explained. In the present embodiment, since a unit of the capacity parameter is the number of the physical blocks, the usable capacity is a value obtained by multiplying the capacity parameter CP by a size (16 kbytes) of the physical block as shown in FIG. 8. The size of the physical block is determined by a type of the nonvolatile memory 210 and is not limited to 16 kbytes. In addition, not only the number of the physical blocks but also other units may be employed as the capacity parameter. For example, the usable capacity itself may be employed as the capacity parameter. In addition, as described below, it is required to preliminarily prepare necessary values (for example, the size of the physical block) used for calculating the usable region based on the value of the capacity parameter so that the access device 100 can acquire the values.

In the initialization processing, the capacity parameter is determined at steps S103 and S104 in the stepwise change mode and is determined at step S107 in the sequence change mode, and in the subsequent normal processing, processing at S105 and S106, or S107 are executed depending on the reduction of the spare blocks.

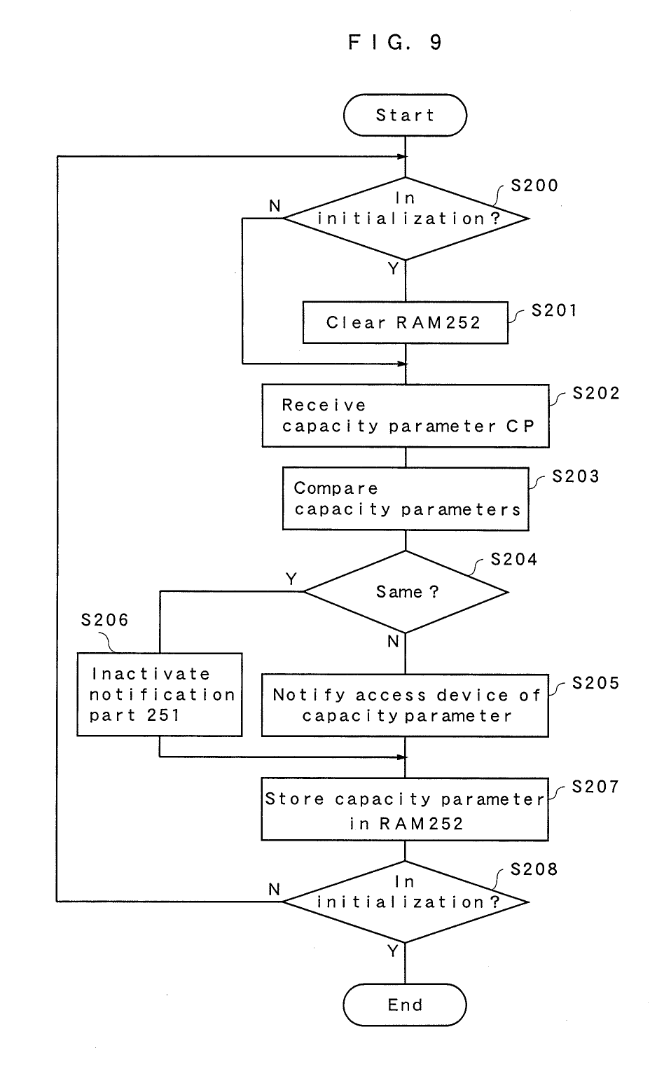

Next, referring to FIG. 9, notification of the capacity parameter executed in the initialization processing will be explained. FIG. 9 is a flowchart showing processing of the capacity parameter 250. In FIG. 9, the interface 230 detects that the nonvolatile memory device is attached to the access device 100 and the power source is supplied from the access device 100, and notifies the capacity parameter notification part 250 of the initial state. Upon receiving the notification, the capacity parameter notification part 250 determines to perform the initialization processing (S200), and clears the RAM 252 (S201).

After that, the capacity parameter notification part 250 receives the capacity parameter CP from the capacity parameter determination part 260 (S202). The comparing part 253 compares the parameter value retained in the RAM 252 with the received capacity parameter value (S203). Since the parameter value retained in the RAM 252 is the value 0 in the initialization processing and the capacity parameter CP never becomes the value 0 in the initialization, they certainly differ from each other as a comparison result (S204). After that, the comparing part 253 activates the notification part 251, and the notification part 250 outputs the capacity parameter with a notification command to the access device 100 via the interface 230 (S205). Then, the RAM 252 stores the received capacity parameter (S207). Since the processing is initialization processing, the processing finishes (S208).

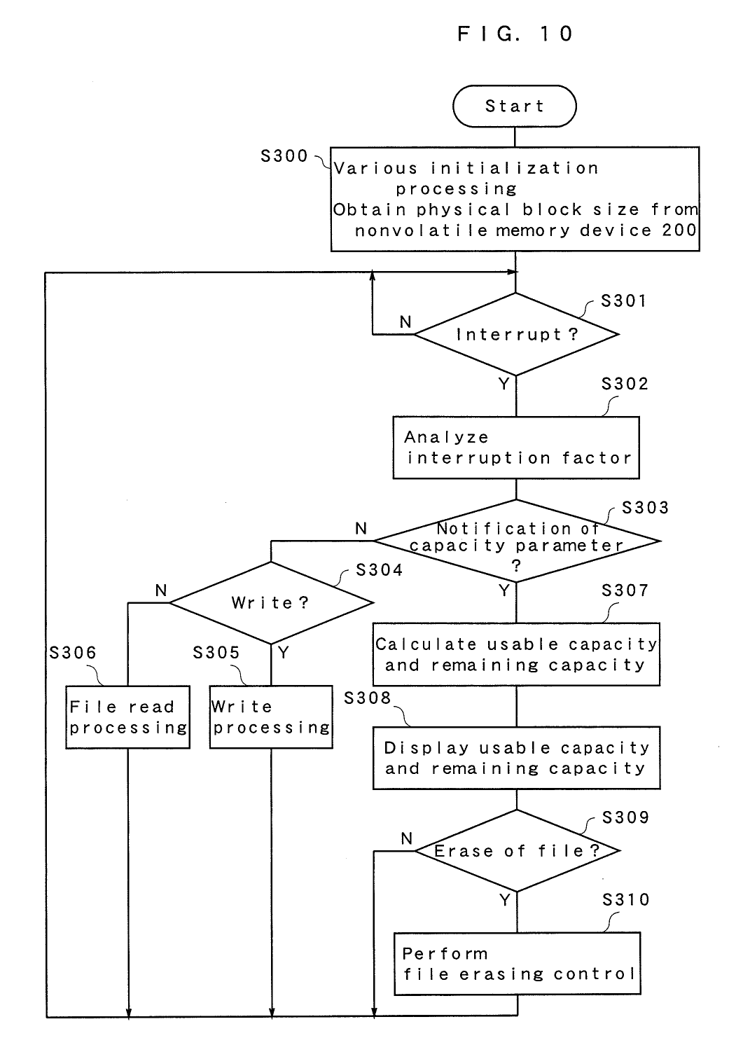

The initialization processing of the access device 100 will be explained. FIG. 10 is a flowchart showing processing of the access device 100. The access device 100 executes the various initialization processing at S300, obtains the physical block size from the nonvolatile memory device 200, and prepares for the calculation of the usable region based on the capacity parameter. Explanations of other processing are abbreviated to simplify the description.

### [Processing in a Normal Operation]

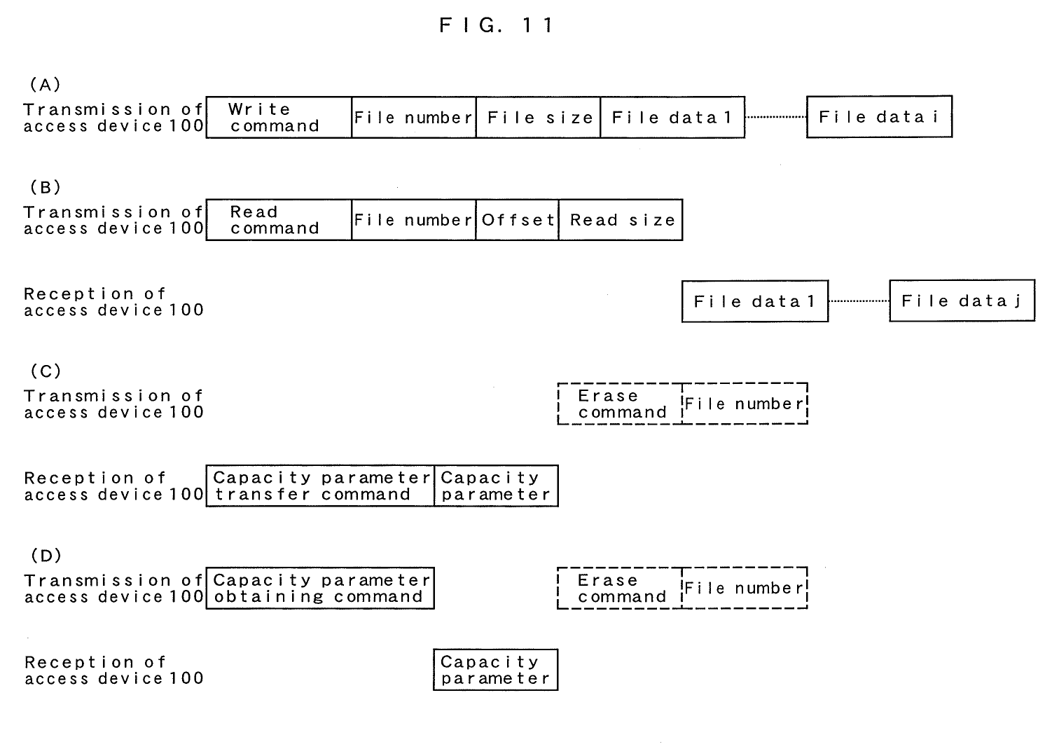

After the above described initialization processing, the nonvolatile memory system shifts to the normal processing. Referring to FIG. 10 and FIG. 11, processing of the access device will be further explained. FIG. 11 is a time chart showing an outline of a communication procedure between the access device 100 and the nonvolatile memory device 200. (A) represents a communication procedure in writing the file data, (B) represents a communication procedure in reading the file data, and (C) and (D) represent communication procedures in notifying the capacity parameter, respectively. The application 120 waits until interrupted by the interface 110 or the user interface 130 (S301), and analyzes a cause of interrupt after the interruption (S302).

When the cause of interrupt is not the notification of the capacity parameter from the nonvolatile memory device 200, the cause of interrupt is determined as an operation related to the recording or reproducing of file by a user via the user interface 130 and the processing proceeds to S304. And, the application 120 analyzes the operation of the user interface 130, executes a file writing control in the case of the recording operation (S305), and executes a file reading control in the case of the reproducing operation (S306).

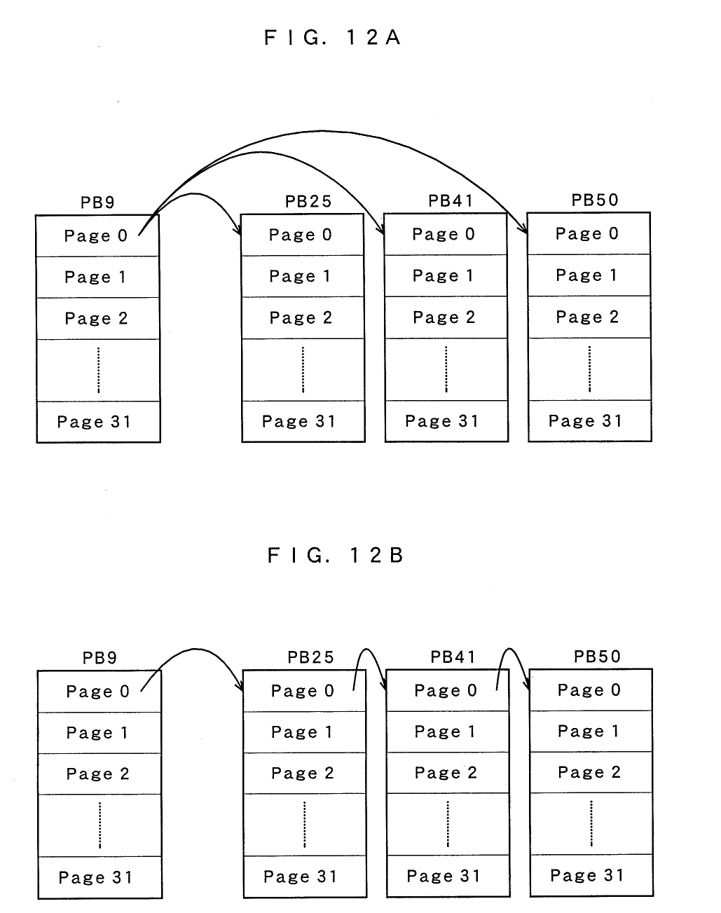

In the case of writing a file, the application 120, as shown in FIG. 11(A), issues a write command to the nonvolatile memory device 200 via the interface 110, and subsequently transfers a file number, a file size, and file data. Suffixes, 1 to i, are added to the file data for each size of the physical block. FIG. 12A and FIG. 12B are explanation views showing a linkage of physical blocks in the nonvolatile memory device 200 storing a file data. When the interface 230 receives a write command, a file number, a file size, and file data (file data 1 to file data i), the interface 230 firstly notifies the read and write controller 240 of a write processing order. Here, the file number is “0”, and further the “i” is “4”, namely, which means the size of the file data corresponds to a size of four physical blocks.

Referring to the physical region management table 241, the read and write controller 240 obtains the numbers of four erased blocks for file data 1 to file data 4, for example, PB9, PB25, PB41, and PB50, and stores the physical block PB9 corresponding to the file data 1 among the obtained four blocks at a position of the file number 0 in the mapping table 242. After that, the read and write controller 240 writes the file data 1 to pages 0 to 31 in the physical block PB9 in series, and writes the file data 2 to 4 to the physical blocks PB25, PB41, and PB50, respectively in the same manner. The physical block numbers indicating the physical blocks PB25, PB41, and PB50 are stored in the management region of the page 0 in the physical block PB9. In addition, as shown in FIG. 12B, the number of the physical block storing next data may be written to the management region of the lead page in the physical block.

In the above described processing, when a writing error occurs, the error is notified from the nonvolatile memory 210 to the read and write controller 240. When receiving the error, the read and write controller 240 changes a block status into the value 10 (the bad block), corresponding to the number of the physical block number generating the error in the physical region management table 241. The read and write controller 240 refers to the physical region management table 241 again, and, after obtaining an erased block, retries the writing to the obtained erased block. This retry of writing is referred to as an alternative processing, and the number of the blocks in the spare region reduces by one, for example, in FIG. 4A. As a block to be alternatively used, any physical blocks may be obtained if the physical block is already erased. However, it is preferable to select the blocks to be obtained by rotation, for example, in the physical region management table 241 so that the writing cannot concentrate to a certain physical block.

As described above, the error in the writing process increases the bad block number BBN registered to the physical region management table 241. The capacity parameter determination part 260 updates the capacity parameter by successively referring to the physical region management table 241 as shown in FIG. 7. When the bad block number increases, the capacity parameter determination part 260 reduces the capacity parameter based on the stepwise change mode or the successive change mode.

In the case of reading a file, the application 120 issues a reading command to the nonvolatile memory device 200 via the interface 110 as shown in FIG. 11(B), and after that transfers the file number, an offset, and a reading size. The offset specifies a lead portion to be read of the file data. Then, the application 120 receives the file data from the nonvolatile memory device 200.

Next, when the nonvolatile memory device 200 transmits a capacity parameter transfer command (corresponding to the interrupt) and the capacity parameter, it is an interruption factor to the access device 100. FIG. 11(C) shows the transferring of the capacity parameter from the nonvolatile memory device 200. In this case, at S307, the usable capacity and a remaining capacity are calculated by operating expression (6) and expression (7) based on the capacity parameter CP received by the application 120. The application 120 successively retains the total capacity of the file dada already written to the nonvolatile memory device 200 by the application 120:

Usable capacity=CP×(Physical block size) (6),

Remaining capacity=Usable capacity−(Total capacity of file data) (7).

The application 120 transfers the usable capacity and the remaining capacity to the user interface 130, and displays the usable capacity and the remaining capacity received by the user interface 130 on the display 132 (S308). In a case where a user does not require the erasure since the sufficient capacity remains, for example, the erasure command is not issued to the nonvolatile memory device 200, however, when the sufficient capacity does not remain, the already written file data is required to be erased. On this occasion, the total capacity manager 121 may detect that the remaining capacity is smaller than a threshold value and output a message recommending the file erasure to the user on the display 132. When the user determines it is better to create a free region based on the displayed remaining capacity, the user operates the erasure (S309). The user designates the erasure of file to the application 120 and designates the file number of file data to be erased to the nonvolatile memory device 200 via the input part 131 of the user interface 130. Here, the file number to be erased is “0”. In this case, the processing proceeds from S309 to S310, the user erases the file data already recorded in the nonvolatile memory device 200 in accordance with the file erasing operation (S310).

In the case of erasing a file, the erasing command and the file number to be erased are transferred to the nonvolatile memory device 200 via the nonvolatile memory device interface 130 as shown in FIG. 11(C). The application 120 changes the file name into the file number.

The read and write controller 240 obtains the physical block number (PB9) stored at a position of the file number “0” in the mapping table 242, and reads a pointer recorded in the management region of PB9. For example, in the case of FIG. 12A, since PB25, PB41, and PB50 are collectively recorded in the management region in PB9, it can be known that the file data of the file number “0” is composed of 4 physical blocks. The read and write controller 240 physically erases PB9, PB25, PB40, and PB50 by transmitting an erasing order, and further changes the corresponding block statuses in the physical region management table 241 into the value 11.

In addition, as shown in FIG. 11(D), the access device 100 may transfer a capacity parameter obtaining command to the nonvolatile memory device 200. Thus, the nonvolatile memory device 200 transfers the capacity parameter. According to this, the usable capacity and the remaining capacity are calculated and displayed at step S307 or after, erasure processing is executed if it is required to erase a file.

In the above described embodiment, when the capacity parameter reduces in a stepwise fashion, the change is notified in the stepwise change mode, and every time the block number of the capacity parameter reduces in the successive change mode, the capacity parameter is notified. As an alternative way, the capacity parameter reduces in the successive change mode every time the bad block increases, and notice thereof may be performed in a stepwise fashion. In addition, since the capacity parameter continuously reduces every time the bad block number increases in the successive change mode, the spare block may be one block from the beginning so that the capacity of the less frequently used nonvolatile memory device can be set large.

As described above, the nonvolatile memory system shown in the embodiment of the present invention does not premise the “logical level access method” as a conventional nonvolatile memory system but premises the “access method based on a file ID” in which an access device 100 designates a file to be read and written from and to a nonvolatile memory device 200. Since the nonvolatile memory device 200 generates the capacity parameter related to the usable capacity for the access device 100 and notifies the access device 100 of the parameter, the present invention dispenses with a complicated conventional processing where the access device 100 manages a certain clusters on the logical address space so as not to be used.

That is, in the embodiment, the capacity parameter is reduced based on the bad block number even when the bad block number in the nonvolatile memory device 200 exceeds the spare block number. This can keep the nonvolatile memory device 200 used in the normal mode (a mode allowing the reading and writing). For this reason, the value of the spare block number “m” may be small, and a substantially usable capacity can be increased by using the nonvolatile memory same as a conventional memory if a frequency of use of the memory is low.

### INDUSTRIAL APPLICABILITY

The nonvolatile memory system according to the present invention proposes a method for extending a life of the nonvolatile memory device, and has an advantage in a still image recording and reproducing apparatus and a motion picture recording and reproducing apparatus using the nonvolatile memory device such as a semiconductor memory card or in a mobile phone.

1. A memory controller which is connected to a nonvolatile memory, comprising:
a read and write controller for writing data and reading data from said nonvolatile memory in accordance with a file ID designated by an outside;
a capacity parameter determination part for determining a usable capacity parameter of said nonvolatile memory depending on a degree of defects of said nonvolatile memory; and
a capacity parameter notification part for notifying the outside of said capacity parameter.

2. The memory controller according to claim 1, wherein
said capacity parameter determination part reduces the capacity parameter every time the bad block number of said nonvolatile memory increases.

3. The memory controller according to claim 1, wherein
said capacity parameter determination part reduces the capacity parameter in a stepwise fashion every time the bad block number of said nonvolatile memory increases in stepwise fashion.

4. The memory controller according to claim 1, wherein,
every time a value of said capacity parameter is changed, said capacity parameter notification part notifies the outside of the change.

5. The memory controller according to claim 1, wherein,
when a value of said capacity parameter is changed by a certain amount, said capacity parameter notification part notifies the outside of the change.

6. A nonvolatile memory device which writes data and reads data from said nonvolatile memory in accordance with a file ID designated by an outside, wherein
said nonvolatile memory device includes:
the nonvolatile memory; and
a memory controller for writing and reading data to and from said nonvolatile memory, and
said memory controller includes:
a read and write controller for writing data to said nonvolatile memory and reading data from said nonvolatile memory in accordance with a file ID designated by an outside;
a capacity parameter determination part for determining a usable capacity parameter of said nonvolatile memory depending on a degree of defects of said nonvolatile memory; and
a capacity parameter notification part for notifying the outside of said capacity parameter.

7. The nonvolatile memory device according to claim 6, wherein,
every time a value of said capacity parameter is changed, said capacity parameter notification part notifies the outside of the change.

8. The nonvolatile memory device according to claim 6, wherein,
every time a value of said capacity parameter is changed by a certain amount, said capacity parameter notification part notifies the outside of the change.

9. The nonvolatile memory device according to claim 6, wherein
said nonvolatile memory is composed of a plurality of physical blocks, and a plurality of said physical block includes: normal blocks used for reading and writing data; and a spare block used for a substitute of a bad physical block, and
said capacity parameter determination part reduces the number of the normal blocks of said nonvolatile memory in accordance with increase of the bad physical block.

10. The nonvolatile memory device according to claim 9, wherein
said capacity parameter determination part reduces the capacity parameter every time the bad block number of said nonvolatile memory increases.

11. The nonvolatile memory device according to claim 9, wherein
said capacity parameter determination part reduces the capacity parameter in a stepwise fashion every time the bad block number of said nonvolatile memory increases in a stepwise fashion.

12. A nonvolatile memory system comprising: an access device; and a nonvolatile memory device which writes data and reads data from a nonvolatile memory in accordance with a file ID designated by said access device, wherein
said nonvolatile memory device includes:
the nonvolatile memory and a memory controller, and
said memory controller includes:
a capacity parameter determination part for determining a usable capacity parameter of said nonvolatile memory depending on a degree of defects of said nonvolatile memory; and
a capacity parameter notification part for notifying said access device of said capacity parameter.

13. The nonvolatile memory system according to claim 12, wherein,
every time a value of said capacity parameter is changed, said capacity parameter notification part notifies the outside of the change.

14. The nonvolatile memory system according to claim 12, wherein,
every time a value of said capacity parameter is changed by a certain amount, said capacity parameter notification part notifies the outside of the change.

15. The nonvolatile memory system according to claim 12, wherein
said nonvolatile memory is composed of a plurality of physical blocks, and a plurality of said physical block includes: normal blocks used for reading and writing data; and a spare block used for a substitute of a bad physical block, and
said capacity parameter determination part reduces the number of the normal blocks of said nonvolatile memory in accordance with increase of the bad physical block.

16. The nonvolatile memory system according to claim 15, wherein
said capacity parameter determination part reduces the capacity parameter every time the bad block number of said nonvolatile memory increases.

17. The nonvolatile memory system according to claim 15, wherein
said capacity parameter determination part reduces the capacity parameter in a stepwise fashion every time the bad block number of said nonvolatile memory increases in a stepwise fashion.

18. An access device which connects with a nonvolatile memory device including a nonvolatile memory, writes data to said nonvolatile memory device and reads data from said nonvolatile memory in accordance with a file ID, wherein
said access device includes:
a receiver for receiving a capacity parameter from said nonvolatile memory device;
an application for reading and writing data from and to said nonvolatile memory device by designating the file ID and for calculating a usable capacity of said nonvolatile memory device based on said capacity parameter; and
a display for displaying information related to the usable capacity of said nonvolatile memory device.

19. The access device according to claim 18, wherein
said application calculates a remaining capacity by subtracting a capacity of data recorded to said nonvolatile memory device from the usable capacity of the nonvolatile memory device calculated based on said capacity parameter, and
said display displays the usable capacity and the remaining capacity of said nonvolatile memory device.

20. The access device according to claim 19, wherein
said application includes: a total capacity manager for detecting that the calculated remaining capacity is equal to or less than a threshold value, and
said display displays a file erasure outputted from the total capacity manager.
